(19) United States
(12) Patent Application Publication
(10) Pub. No.: US 2015/0134843 A1
(43) Pub. Date: May 14, 2015

(54) METHOD OF ESTABLISHING NETWORK CONNECTION AND SYSTEM THEREOF

(71) Applicant: Service & Quality Technology Co., Ltd., Taipei City (TW)

(72) Inventors: CHING-CHANG HSIEH, Taipei City (TW); YU-CHUAN KAO, Taipei City (TW); CHIH-CHUNG WU, Taipei City (TW)

(21) Appl. No.: 14/537,105

(22) Filed: Nov. 10, 2014

(30) Foreign Application Priority Data
Nov. 12, 2013 (TW) 102141007

(51) Int. Cl. H04L 29/08

(52) U.S. Cl. CPC H04L 67/141; H04L 67/104
USPC 709/228

(57) ABSTRACT

A method of establishing network connection for peer-to-peer connection between a first network device and a second network device includes a first server receiving a connection request package from the first network device according to a first match table. The first server confirms the second network device being connected thereto. The first server confirms the address type of the first network device and the second network device and transmits a connection signaling package to the second network device. The first server receives a connection response package sent by the second network device according to a second match table and the first server confirms connection according to the connection request package and the connection response package. Then, the first network device and the second network device establish connection.

### BACKGROUND

1. Field of the Invention

The instant disclosure relates to a network system and a method of establishing network connection; in particular, to a system establishing peer to peer connection between a first network device and a second network device and the method of establishing the connection.

2. Description of Related Art

The development of Internet and the application thereof have increased. The reliance on Internet grows considerably. Therefore the number of computers that needs to connect to the Internet increases dramatically. However, the number of public IP address is limited, and the available public IP address is seriously lower than the demand.

To allow more computer devices to connect to the Internet, the network address translation (NAT) technique is developed. NAT translates a private IP to a public IP. More specifically, in the private domain, if a computer is going to link to the Internet, NAT server translates the sending address to the only IP address (i.e., public IP address), such that the computer device in a private domain can load the data on the Internet. In this way, NAT partially relieves the burden of insufficient IP address. Although NAT allows computer devices in private domain to load data from the Internet, the computer device excluded from the private domain cannot actively exchange data with the computer device in private domain. Specifically, computer device in private domain uses NAT to translate the sending IP address to a public IP address and send to the Internet, while if another external computer device is going to send package to a computer device in private domain (without actual public IP), it requires manual port mapping to achieve the goal. Otherwise, the package sent by the external computer device will be discarded and fail the transmission. However, port matting requires manually configuring several parameters. If NAT server has many computer devices, it takes a great amount of time to complete all the port mapping configuration, which is time consuming and inconvenient.

Furthermore, conventional point-to-point connection is established by logging in to a server to verify its identity. Computer device passing the verification can share private data to the server. Therefore the server has to store all the membership information and information table of each computer device, such that when a data loading request prompts out, the server can signal the location of the data in which computer device, and the requesting end can establish peer-to-peer connection to the destination end. However, the server has to store all the membership information and data table, such that when too many computer devices are present, the server is overloaded. Therefore, the hardware of the server has to be expanded and the cost increases as well.

### BRIEF SUMMARY OF THE INVENTION

The instant disclosure provides a method of establishing network connection for establishing peer-to-peer connection among a plurality of network devices, and the plurality of network devices includes at least a first network device and a second network device. The method includes a first server receiving a connection request package. The first network device sends the connection request package according to a first match table sending a request for establishing connection with the second network device. Then the first server confirms the second network device being connected to the first server. Following that, the first server confirms the type of network address of the first and second network devices and sends a connection signaling package to the second network device. Next, the first server receives a connection response package. The connection response package is sent by the second network device according to a second match table. Finally, the first network device establishing connection with the second network device after the first server confirming connection request package and the connection response package. The first match table is stored in the first network device, the second match table is stored in the second network device, the second match table includes a first identifier in response to the first network device, and the first match table includes a second identifier in response to the second network device.

According to one embodiment of the instant disclosure, the connection request package and the connection response package include the first identifier and the second identifier.

In another embodiment of the instant disclosure, before the step of the first server receiving the connection request package further includes: the first and second network devices executing a matching process by connecting to the first server and the first and second network device respectively establishing the first and second match tables.

In another embodiment of the instant disclosure the matching process includes: the first network device transmitting a matching request package to the first server. The first network device includes the second identifier in response to the second network device, and the matching request package includes the second identifier. The first server transmits a matching signaling package to the second network device according to the matching request package. Then the second network device responds with a matching response package to the first server according to the matching signaling package, and the second network device receives the first identifier in response to the first device through the first server. Finally, the first server transmits a first confirming package to the first and second network devices respectively to signal the first and second network devices of matching completion. After the first and second network devices are matched, the first and second network devices establish the first match table and the second match table respectively.

In another embodiment of the instant disclosure, the first and second match tables are established in the first and second network devices in advance.

In another embodiment of the instant disclosure, the step of the second network device establishing connection with the first network device further includes: if the address type of the first and second network devices being a public address or if the address type of the first network device being a private address and the second network device being a public address, the first server transmitting a second confirmation package to the first and second network devices respectively, such that the first and second network devices establish connection.

In another embodiment of the instant disclosure, the step of the second network device establishing connection with the first network device further includes: if the address type of the first network device being a public address and the address type of the second network device being a private address, the first server transmitting a second confirmation package to the first and second network devices respectively to facilitate the second network device transmitting a connection confirmation package to the first server, such that the second network device establishes connection with the first network device.

In another embodiment of the instant disclosure, the step of the second network device establishing connection with the first network device further includes: if the address type of the first and second network devices being private address, the first server transmitting a second confirmation package to the first and second network devices respectively. Then, the first and second network devices respectively transmit a hole punching request package to the first server. After that, the first server transmits a first hole punching confirmation package and a second hole punching confirmation package to the second and first network devices respectively. The first hole punching confirmation package includes a public address and a public port number of the first network device, and the second hole punching confirmation package includes a public address and a public port number of the second network device. Finally, the first and second network devices inter-transmit a first user data protocol package and a second user data protocol package, and the first network device and the second network device establish connection.

In another embodiment of the instant disclosure, before the step of the first server receiving the connection request package further includes: the first and second network devices establishing connection to a control server. Then, the control server receives the public address of the first and second network devices. Next, the control server obtains the location of the first and second network devices according to the public addresses of the first and second network devices. Finally, the control server selects the first server from a plurality of servers according to the location of the first and second network devices so as to allow the first and second network devices to establish connection.

In another embodiment of the instant disclosure, when the first server is malfunctioned, the control server selects a second server from the plurality of servers to replace the first server, such that the first and second network devices establish connection with the second server.

According to one embodiment, the instant disclosure also provides a network system. The network system includes a server and a plurality of network devices. The plurality of network devices includes at least a first network device and a second network device, the first network device and the second network device are respectively connected to the server. The first network device transmits a connection request package to the server according to a first match table, the server confirms the address type of the first and second network devices and transmits a connection signaling package to the second network device, the second network device transmits a connection response package according to a second match table, the server confirms the connection request package and the connection response package are matched, and the first network device establishes connection with the second network device.

In summary, the instant disclosure provides the network system and the method of establishing connection thereof. The first and second match tables are built in the first and second network devices in advance. If the first and second network devices are going to be connected, after the first server compares the connection request package sent by the first network device and the connection response package sent by the second network device, the first and second network devices automatically proceed with associated connection process, such that the first and second network devices establish connection. In this way, users do not need to configure each network parameters of the first and second network devices manually, and the first server does not need to store a data table for the first and second network device to share the information. In the instant disclosure, after verifying the identity information of the first and second network devices and found matched, the first and second network devices execute specific connection action in response to the address type, such that peer-to-peer connection can be established and the loading of the first server is reduced.

In order to further understand the instant disclosure, the following embodiments are provided along with illustrations to facilitate the appreciation of the instant disclosure; however, the appended drawings are merely provided for reference and illustration, without any intention to be used for limiting the scope of the instant disclosure.

### BRIEF DESCRIPTION OF THE SEVERAL VIEWS OF THE DRAWINGS

FIG. 1 is a block diagram showing a network system in accordance with an embodiment of the instant disclosure;

FIG. 2 is a flow chart showing a method of establishing first and second match tables in accordance with an embodiment of the instant disclosure;

FIG. 3 is a flow chart showing a method of establishing network connection in accordance with an embodiment of the instant disclosure;

FIG. 4 is a flow chart showing a method of establishing network connection in accordance with an embodiment of the instant disclosure;

FIG. 5 is a flow chart showing a method of establishing network connection in accordance with another embodiment of the instant disclosure;

FIG. 6 is a flow chart showing a method of establishing network connection in accordance with another embodiment of the instant disclosure; and

FIG. 7 is a block diagram showing a network system in accordance with another embodiment of the instant disclosure.

### DETAILED DESCRIPTION OF THE INVENTION

The aforementioned illustrations and following detailed descriptions are exemplary for the purpose of further explaining the scope of the instant disclosure. Other objectives and advantages related to the instant disclosure will be illustrated in the subsequent descriptions and appended drawings.

It should be understood that the usage of “first”, “second” and “third” intends to distinguish one element from another, and the element should not be limited by the term. Therefore, hereinafter a first element is interchangeable with a second element. The term “and/or” includes one and one or more of the combination in the group as described.

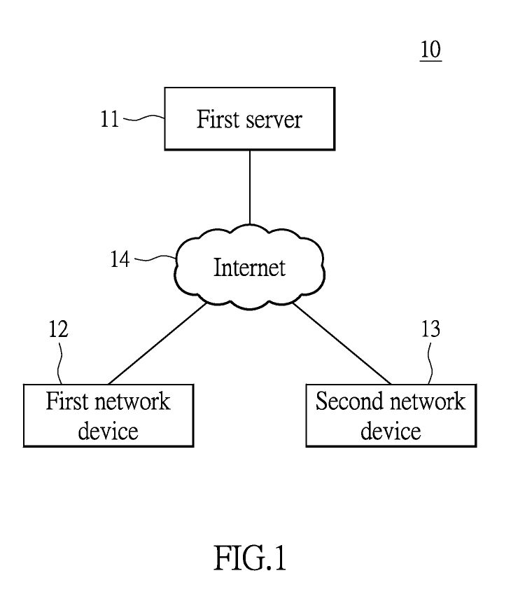

Please refer to FIG. 1. FIG. 1 is a schematic diagram showing a network system structure in accordance with an embodiment of the instant disclosure. As shown in FIG. 1, the network system 10 includes a first server 11, a first network device 12, a second network device 13 and Internet 14. The first network device 12 and the second network device 13 may be laptop, desktop, smart phone, Internet camera or electronic device capable of Internet communication.

In the instant embodiment, the first network device 12 and the second network device 13 are connected to the first server 11 through the Internet 14. Also, according to the first and second match table, the first network device 12 and the second network device 13 undergo comparison through the first server 11, such that the two network devices can establish peer-to-peer Internet connection.

The first and second match tables are built before the first network device 12 and the second network device 13 are dispatched. The manufacturer builds the first match table in the memory of the first network device 12, and the manufacturer builds the second match table in the memory of the second network device 13. The second match table includes a first identifier of the first network device 12, and the first match table includes a second identifier of the second network device 13. The first and second match tables may also have the first identifier of the first network device and the second identifier of the second network device at the same time, and the instant disclosure is not limited thereto. In the instant embodiment, the first and second identifiers may includes user identifier (UID) and password of the first and second network devices 12, 13. However, the instant disclosure is not limited thereto. The first and second identifier may also by other types of verification code. The first and second identifiers may not include any password but only include user identifier (UID), and it is subject to user requirement, and the instant disclosure is not limited thereto.

The number of network device in the network system 10 is not limited in the instant disclosure. In the instant embodiment the first network device 12 and the second network device 13 are used for exemplary purpose, and the network devices can be more than two according to the practical requirement.

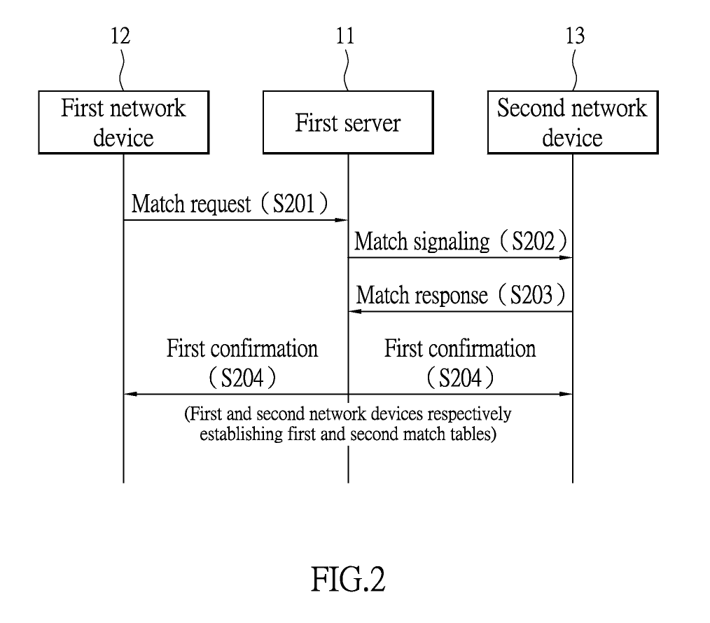

It should be noted that in another embodiment, through a matching process, the user can also manually establish the first and second match tables or add new content to the first and second match tables. More specifically, please refer to FIG. 2. FIG. 2 is a flow chart in accordance with an embodiment of the instant disclosure. Firstly, the first network device 12 and the second network device 13 are connected to the first server 11 (i.e., the first network device 12 and the second network device 13 are in online status). After the first network device 12 and the second network device 13 are connected to the first server 11, the first server 11 obtains the identifier of the first network device 12 and the second network device 13. Next, the user operates the first network device 12 to transmit a matching request package to the first server 11 (S201). The matching request package is used to inform the first server 11 that the first network device 12 attempts to match with the second network device 13. The matching request package includes the second identifier of the second network device 13. In the instant embodiment, the user of the first network device 12 has to know the second identifier of the second network device 13. Otherwise, the first network device 12 cannot undergo matching with the second network device 13.

Subsequently, the first server 11 transmits a matching signaling package to the second network device 13 (S202). The matching signaling package is used to inform the second network device 13 that the first network device 12 attempts to undergo matching. The matching signaling package includes the first identifier of the first network device 12 and the second identifier of the second network device 13. The second network device 13 obtains the first identifier of the first network device 12 through the matching signaling package and verifies whether the second identifier in the matching signaling package is correct or not. If the result is correct, the second network device 13 responds with a matching response package to the first server 11 to inform the matching result is matched (S203). The first server 11 transmits a first confirmation package to the first network device 12 and the second network device 13 respectively so as to signal the first network device 12 and the second network device 13 of matching completion (S204). After the matching, the first network device 12 and the second network device 13 establish the first match table and the second match table respectively. Alternatively, the content of the first and second match tables are renewed.

The working theory of the network system and the method of establishing network connection is described hereinafter.

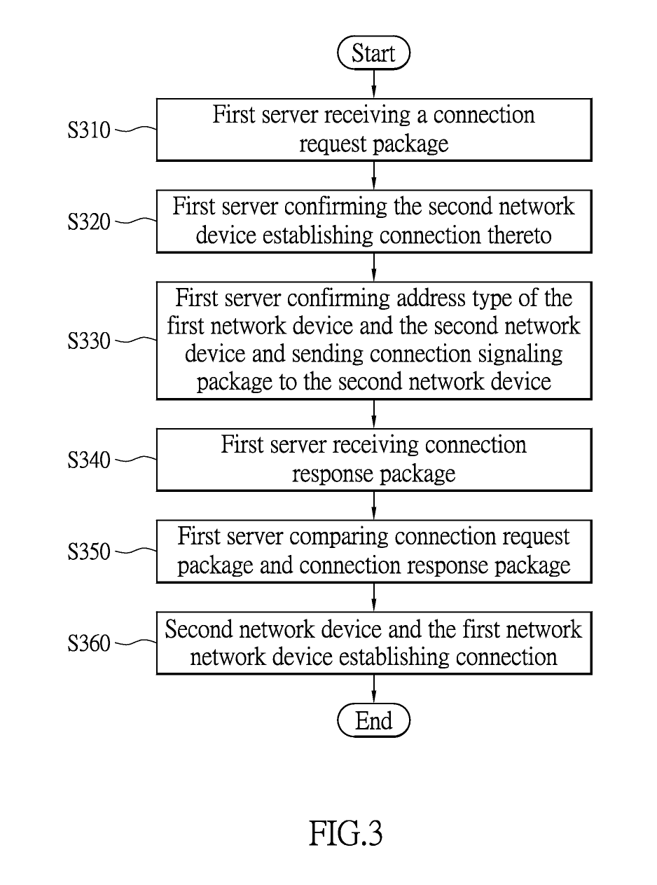

Please refer to FIGS. 1 and 3. FIG. 3 is a flow chart showing the method of establishing network connection in accordance with an embodiment of the instant disclosure. As shown in FIG. 3, the first network device 12 is going to establish peer-to-peer connection with the second network device 13, and the method of establishing the network connection is described in the following steps:

Step S310: the first server 11 receiving a connection request package. More specifically, the first network device 12 is connection to the first server 11 (i.e., the first network device 12 is at online status), and the first network device 12 sends connection request package to the first server 11. The connection request package includes the first identifier of the first network device 12 and the second identifier in response to the second network device 13.

Step S320: the first server 11 confirming the second network device 13 being connected thereto. More specifically, according to the received connection request package, the first server 11 detects whether the second network device 13 is connected to the first server 11 or not (i.e., detect whether the second network device 13 is at online status or not). If the second network device 13 is not connected, the first server 11 holds until the second network device 13 establishes connection with the first server 11.

Step S330: the first server 11 confirming the address type of the first network device 12 and the second network device 13 and transmitting connection signaling package to the second network device 13. Specifically, after the first network device 12 and the second network device 13 are connected to the first server 11, the first server further confirms the address type of the first network device 12 and the second network device 13 (i.e., whether the address type is public IP or private IP) according to the connection request package. Furthermore, the first server 11 sends connection signaling package to the second network device 13 to inform the second network device 13 that the first network device 12 is going to establish connection thereto. The connection signaling package includes the first identifier of the first network device 12.

Step S340: the first server 11 receiving connection response package. Specifically, after the second network device 13 receives connection signaling package, the first server 11 receives the connection response package from the second network device 13. The connection response package includes the second identifier in response to the second network device 13 and the first identifier in response to the first network device 12. The first identifier of the network device 12 is sent by the second network device 13 according to the second match table.

Step S350: the first server 11 comparing the connection request package and the connection response package. More specifically, when the first server 11 receives the connection response package, the first server 11 compares the connection request package and the connection response package and confirms whether the content of the connection request package and the connection response package match or not (i.e., whether the first and second identifiers of the connection request package and the connection response package match). If the content matches, the process enters step S360. If the content does not match, the first network device 12 and the second network device 13 cannot establish peer-to-peer connection.

Step S360: the second network device 13 establishing connection with the first network device 12. More specifically, when the first server 11 compares the connection request package and the connection response package and they match, the first network device 12 and the second network device 13 execute a connection mode to establish connection. According to the address type of the first network device 12 and the second network device 13, the connection mode can be divided into a first, a second and a third connection modes which will be further discussed hereinafter.

The working theory of the network system and method of establishing network connection in accordance with another embodiment of the instant disclosure is elaborated hereinafter.

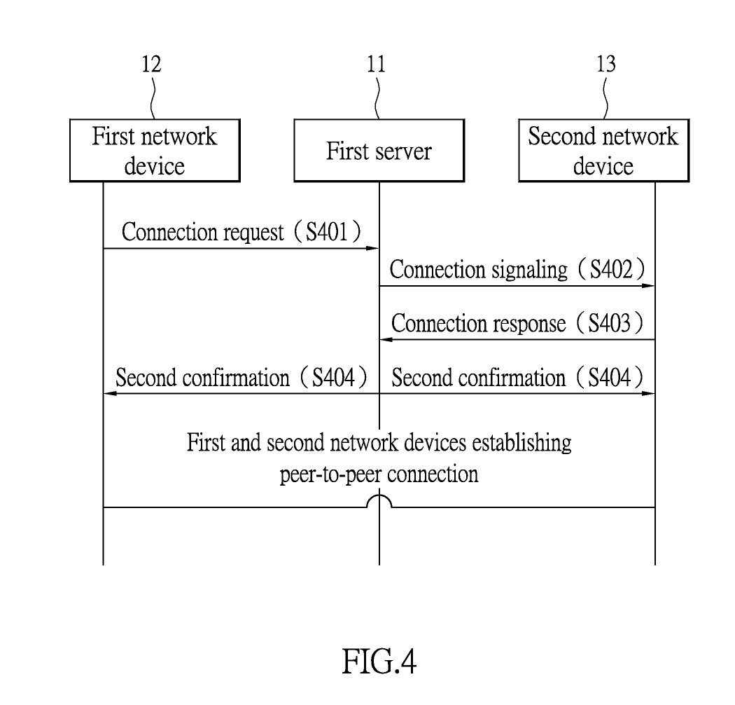

Please refer to FIG. 4. FIG. 4 is a flow chart showing the method of establishing network connection in accordance with an embodiment of the instant disclosure. In the instant embodiment, the first network device 12 and the second network device 13 shown in FIG. 4 have public IP address. That is to say, the first network device 12 and the second network device 13 do not need NAT server to translate from a private address to a public address. Both of the first and second network devices have the globally only IP address. Alternatively, the address type of the first network device 12 is a private IP and the address type of the second network device 13 is a public IP address. As shown in FIG. 4, when the first network device 12 is connected to the first server 11, and the first network device 12 actively sends connection request package which includes the first and second identifiers according to a first match table to the first server 11 (S401), the first server 11 transmits connection signaling package to the second network device 13 (the first server 11 has confirmed the connection with the second network device 13 in advance) to inform the second network device 13 that the first network device 12 is going to establish connection (S402). Then, according to the connection signaling package which includes the first identifier, the second network device 13 retrieves the first identifier from the second match table and responds with the connection response package which includes the first and second identifiers to the first server 11 (S403). Subsequently, the first server 11 compares whether the connection request package and the connection response package match. If they are matched, the first server 11 transmits a second confirmation package to the first network device 12 and the second network device 13 to inform the first network device 12 and the second network device 13 that they can execute the first connection mode (S404). Following that, the first network device 12 and the second network device 13 execute the first connection mode. In other words, the first network device 12 directly establishes peer-to-peer connection with the second network device 13.

Another embodiment is further described hereinafter.

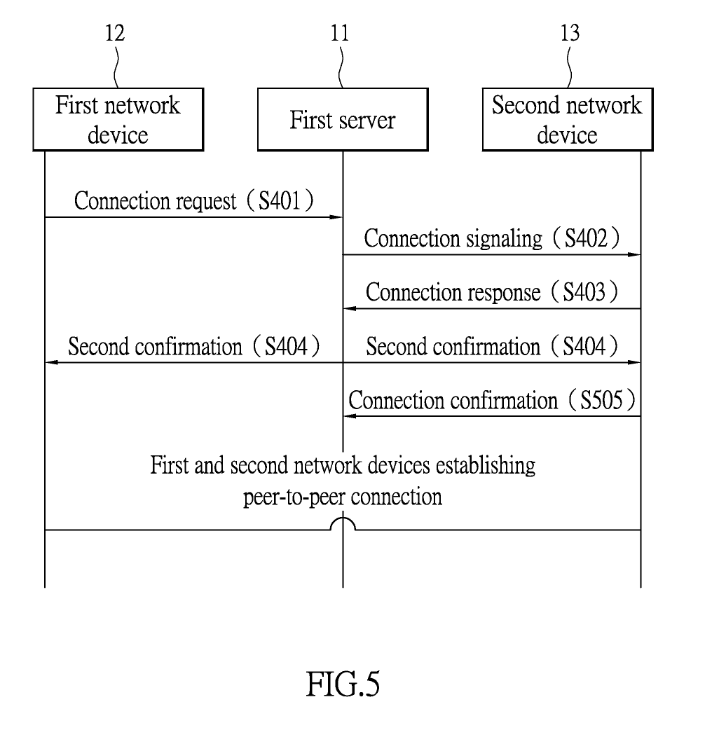

Please refer to FIG. 5 which shows a flow chart of the method of establishing network connection in accordance with an embodiment of the instant disclosure. In the instant embodiment, the address type of the first network device 12 is a public IP address and the second network device 13 is a private IP address. The difference between the instant embodiment (FIG. 5) and the previous embodiment (FIG. 4) arises from that after the first server 11 transmits a second confirmation package to the first network device 12 and the second network device 13, the first network device 12 and the second network device 13 execute the second connection mode, such that the first network device 12 and the second network device 13 establish peer-to-peer network connection. More specifically, according to the second confirmation package, the second network device 13 actively transmits a connection confirmation package to the first server 11 (S505). In this way, the first network device 12 and the second network device 13 can undergo peer-to-peer network connection. The remaining process remains the same as the previous embodiment.

Another embodiment is further described hereinafter.

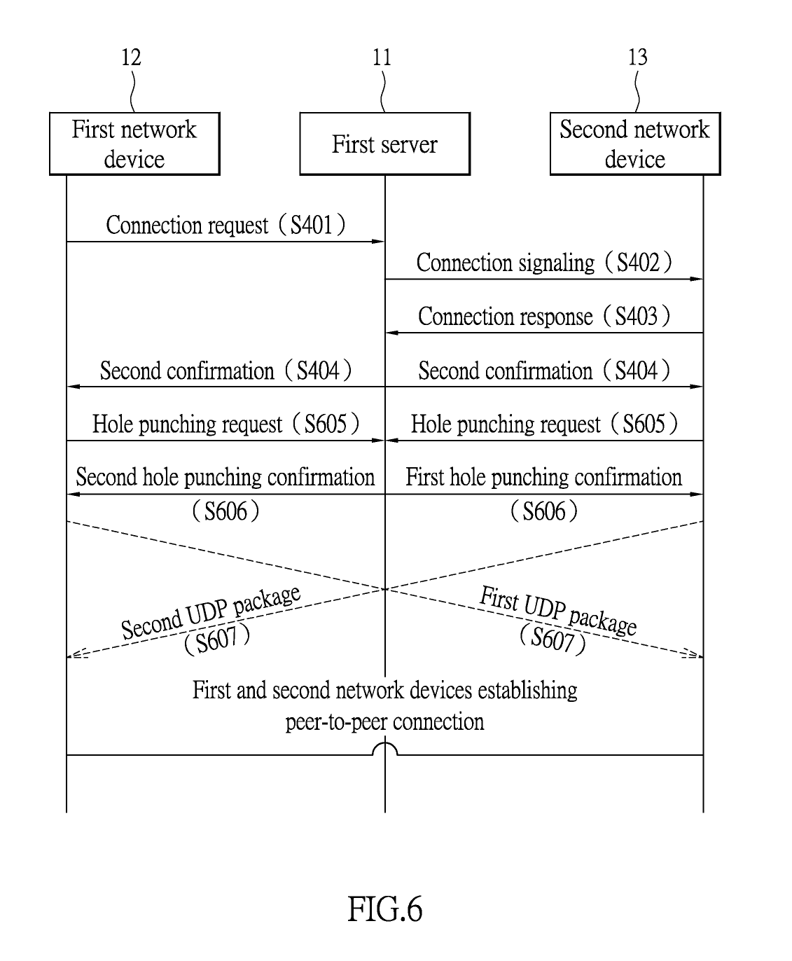

Please refer to FIG. 6 which shows a flow chart of the method of establishing network connection in accordance with an embodiment of the instant disclosure. In the instant embodiment, the first network device 12 and the second network device 13 as shown in FIG. 6 have private address. The difference between the embodiment shown in FIG. 6 and FIG. 4 arises from that after the first server 11 transmits the second confirmation package to the first network device 12 and the second network device 13, the first network device 12 and the second network device 13 execute the third connection mode by the first server 11, such that the first network device 12 and the second network device 13 can establish peer-to-peer network connection. More specifically, after the first network device 12 and the second network device 13 receive the second confirmation package, the first network device 12 and the second network device 13 transmit a hole punching request package to the first server 11 respectively, such that the first server executes the hole punching process (S605). In other words, according to the hole punching request package, the first server 11 is requested to transmit the public address and port number of the first network device 12 to the second network device 13 and transmits the public address and port number of the second network device 13 to the first network device 12. Next, the first server 11 transmits a second hole confirmation package to the first network device 12, and the first server 11 transmits a first hole punching confirmation package to the second network device 13 (S606). The first hole punching confirmation package includes the public address and port number of the first network device (e.g., 155.99.25.11:620000), and the second hole punching confirmation package includes the public address and port number of the second network device (e.g., 138.76.29.7:31000). Subsequently, according to the public address and port number from both sides, the first network device 12 and the second network device 13 exchange a first user data protocol (UDP) package and a second user data protocol (UDP) (S607). Furthermore, the first network device 12 sends UDP package (i.e., package assigning port 31000) to the second network device 13 according to the public address and port number of the second network device (i.e., 138.76.29.7:31000), and the second network device 13 sends the UDP package (i.e., package assigning port 62000) to the first network device 12. Therefore, the first network device 12 and the second network device 13 can establish peer-to-peer Internet connection. The identical features between the instant embodiment and the embodiment shown in FIG. 4 are not repeated herein.

In FIGS. 4, 5 and 6, although the first network device 12 actively sends connection request, to any skilled in the art, the Internet connection method of the instant disclosure may also be initialized by the second network device 13, and the subsequent process is the same as the previous embodiment and not repeated herein.

Another embodiment of the instant disclosure is elaborated hereinafter.

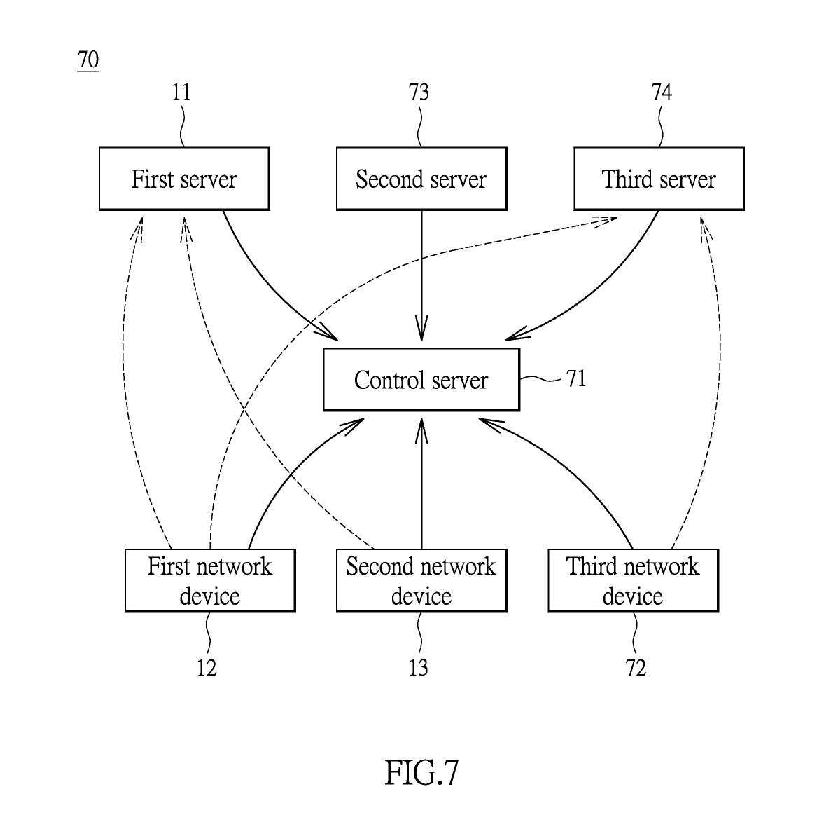

Please refer to FIG. 7. FIG. 7 shows a schematic diagram of the structure of the network system in accordance with another embodiment of the instant disclosure. As shown in FIG. 7, the difference between the network system in the embodiment of FIG. 7 and FIG. 1 lies on the network system 70 further including a control server 71, a third network device 72, a second server 73 and a third server 74. The third network device 72 is the same as the first network device 12 and the second network device 13 may be laptop, desktop, smart phone, Internet camera or any electronic device capable of Internet communication. It should be understood that the number and implementation of the network device and server of the network system 70 are not limited, and the instant embodiment is for exemplary purpose for easier understanding to one skilled in the art. One skilled in the art can change the configuration according to practical requirement. The control server 71 selects at least one suitable server from the first server 11, second server 73 and third server 74 according to the user identity code (e.g., UID code) and public IP address of the first network device 12, second network device 13 and third network device 72, such that the first network device 12, the second network device 13 and the third network device 72 can be interconnected.

Specifically, under the network system 70, the first server 11, second server 73 and third server 74 are connected to the control server 71, and the first network device 12, second network device 13 and third network device 72 are connected to the control server 71. After the first network device 12, second network device 13 and third network device 72 are connected to the control server 71, the control server 71 obtains the public IP address and UID code of the first network device 12, second network device 13 and third network device 72. According to the public IP address and the code content, the control server 71 determines the location (e.g., Taiwan or the States) where the first network device 12, second network device 13 and third network device 72 are.

Next, according to the country where the first network device 12, second network device 13 and third network device 72 are, the control server 71 selects a suitable server from the first server 11, second server 73 and third server 74 to assign to the first network device 12, second network device 13 and third network device 72. For example, if the location of the first network device 12 is in the U.S., the control server 71 selects the suitable server (from the first server 11, second server 73 and third server 74) in the same location as the first network device 12 for connection. Similarly, according to the UID code of the first network device 12, second network device 13 and third network device 72, the control server 71 selects at least one suitable server from the first server 11, second server 73 and third server 74 to interconnect with the first network device 12, second network device 13 and third network device 72.

For example, if the first network device 12 is a mobile device (e.g., tablet or smart phone), and the second network device 13 and third network device 72 are IP cameras, as shown in FIG. 7, the control server 71 assigns the first server 11 to be connected with the first network device 12 and the second network device 13. After the first server 11 is connected with the first network device 12 and the second network device 13, by the method of establishing network connection of the instant disclosure, the first network device 12 and second network device 13 establish peer-to-peer connection, and the first network device 12 can load the data of the second network device 13 (i.e., the user of the first network device 12 can watch instant video captured on the second network device 13). However, when the user of the first network device 12 is going to watch the video captured by the third network device 72, the first network device 12 logs in to the control server 71 again and sends a transfer request package to the control server 71 to inform the control server 71 that the first network device 12 is going to load the data from the third network device 72. In response, the control server 71 assigns the server (i.e., the third server 74) connected to the third network device 72 to the first network device 12 for connection. Therefore, the first network device 12 and the third network device 72 are connected to the third server 74, such that the peer-to-peer connection can be established by executing the method of the instant disclosure. As a result, the first network device 12 can instantly obtain the video captured by the third network device 72.

In addition, please refer to FIG. 7 again. After the third server 74 are assigned to connect with the first network device 12 and the third network device 72, if the third server 74 is overload and cannot function normally or the third server 74 is not started (i.e., the first network device 12 and the third network device 72 cannot connect to the third server 74), in response the control server 71 selects the first server 11 or the second server 73 to replace the third server 74, such that the first network device 12 and third network device 72 can connect to the new server (i.e., first server 11 or second server 73) for data loading.

In summary, in the method of establishing network connection of the instant disclosure, the first and second match tables are built in advance in the first and second network device. If the first network device is going to establish connection with the second network device, the first server compares the connection request package sent by the first network device and the connection response package sent by the second network device. Then the first and second network devices automatically undergo relevant connection procedure (the first, second or third connection mode), such that the first and second network devices can establish connection. In this way, the user does not need to reconfigure each network parameter settings, and the first server does not need to store the data table including the first and second network devices. After the first server verifies the identity of the first and second network devices and finds them match, the first and second network devices can execute specific connection mode for peer-to-peer connection according to their address type.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A method of establishing network connection for establishing peer-to-peer connection among a plurality of network devices, the plurality of network devices including at least a first network device and a second network device, the method comprising:
a first server receiving a connection request package, wherein the first network device sends the connection request package according to a first match table sending a request for establishing connection with the second network device;
the first server confirming the second network device being connected to the first server;
the first server confirming the type of network address of the first and second network devices and sending a connection signaling package to the second network device;
the first server receiving a connection response package, wherein the connection response package is sent by the second network device according to a second match table; and
the first network device establishing connection with the second network device after the first server confirming connection request package and the connection response package;
wherein the first match table is stored in the first network device, the second match table is stored in the second network device, the second match table includes a first identifier in response to the first network device, and the first match table includes a second identifier in response to the second network device.

2. The method of establishing network connection according to claim 1, wherein the connection request package and the connection response package include the first identifier and the second identifier.

3. The method of establishing network connection according to claim 1, wherein before the step of the first server receiving the connection request package further includes:
the first and second network devices executing a matching process by connecting to the first server and the first and second network device respectively establishing the first and second match tables.

4. The method of establishing network connection according to claim 3, wherein the matching process includes:
the first network device transmitting a matching request package to the first server, wherein the first network device includes the second identifier in response to the second network device, and the matching request package includes the second identifier;
the first server transmitting a matching signaling package to the second network device according to the matching request package;
the second network device responding with a matching response package to the first server according to the matching signaling package, and the second network device receiving the first identifier in response to the first device through the first server; and
the first server transmitting a first confirming package to the first and second network devices respectively to signal the first and second network devices of matching completion;
wherein after the first and second network devices are matched, the first and second network devices establish the first match table and the second match table respectively.

5. The method of establishing network connection according to claim 1, wherein the first and second match tables are established in the first and second network devices in advance.

6. The method of establishing network connection according to claim 1, wherein the step of the second network device establishing connection with the first network device further includes:
if the address type of the first and second network devices being a public address or if the address type of the first network device being a private address and the second network device being a public address, the first server transmitting a second confirmation package to the first and second network devices respectively, such that the first and second network devices establish connection.

7. The method of establishing network connection according to claim 1, wherein the step of the second network device establishing connection with the first network device further includes:
if the address type of the first network device being a public address and the address type of the second network device being a private address, the first server transmitting a second confirmation package to the first and second network devices respectively to facilitate the second network device transmitting a connection confirmation package to the first server, such that the second network device establishes connection with the first network device.

8. The method of establishing network connection according to claim 1, wherein the step of the second network device establishing connection with the first network device further includes:
if the address type of the first and second network devices being private address, the first server transmitting a second confirmation package to the first and second network devices respectively;
the first and second network devices respectively transmitting a first hole punching request package and a second hole punching request package to the first server;
the first server transmitting a first hole punching confirmation package and a second hole punching confirmation package to the second and first network devices respectively, wherein the first hole punching confirmation package includes a public address and a public port number of the first network device, and the second hole punching confirmation package includes a public address and a public port number of the second network device;
the first and second network devices inter-transmitting a first user data protocol package and a second user data protocol package; and
the first network device and the second network device establishing connection.

9. The method of establishing network connection according to claim 1, wherein before the step of the first server receiving the connection request package further includes:
the first and second network devices establishing connection with a control server;
the control server receiving the public address of the first and second network devices;
the control server determining the location of the first and second network devices according to the public addresses of the first and second network devices; and
the control server selecting the first server from a plurality of servers according to the location of the first and second network devices so as to allow the first and second network devices to establish connection.

10. The method of establishing network connection according to claim 1, wherein when the first server is malfunctioned, the control server selects a second server from the plurality of servers to replace the first server, such that the first and second network devices establish connection with the second server.

11. A network system comprising:
a server; and
a plurality of network devices including at least a first network device and a second network device, the first network device and the second network device respectively connected to the server;
wherein the first network device transmits a connection request package to the server according to a first match table, the server confirms the address type of the first and second network devices and transmits a connection signaling package to the second network device, the second network device transmits a connection response package according to a second match table, the server confirms the connection request package and the connection response package are matched and the first network device establishes connection with the second network device.

12. The network system according to claim 11, wherein the second match table includes a first identifier in response to the first network device, and the first match table includes a second identifier in response to the second network device.

13. The network system according to claim 12, wherein the connection request package and the connection response package include the first and second identifiers.

14. The network system according to claim 13, wherein if the address type of the first and second network devices are public address or if the address type of the first network device is a private address and the address type of the second network device is a public address, the server transmits a second confirmation package to the first and second network devices respectively, such that the second network device establishes connection with the first network device.

15. The network system according to claim 13, wherein if the address type of the first network device is a public address and the address type of the second network device is a private address, the server transmits a second confirmation package to the first and second network devices respectively, and then the second network device transmits a connection confirmation package to the server, such that the second network device establishes connection with the first network device.

16. The network system according to claim 13, wherein if the address type of the first and second network devices are private address, the server transmits a second confirmation package to the first and second network devices respectively, the first and second network devices respectively transmits a first hole punching request package and a second hole punching request package to the server, the server transmits a first hole punching confirmation package and a second hole punching confirmation package to the second and first network devices respectively, the first and second network devices inter-transmit a first user data protocol and a second user data protocol, such that the first network device establishes connection with the second network device, wherein the first hole punching confirmation package includes a public address and a public port number of the first network device, and the second hole punching confirmation package includes a public address and a public port number of the second network device.

17. The network system according to claim 11, further comprising:
one or more servers disposed at different location; and
a control server to control the network device and the connection in between the servers;
wherein the control server selects a server in response to the network devices from the plurality of servers according to public address of the network devices.

18. The network system according to claim 17, wherein the control server determining the location of the network devices according to the public address of the network devices, and the control server selects at least one server from the plurality of servers according to the location of the network devices, such that the network devices are capable of interconnecting.

19. The network system according to claim 18, wherein when one of the network devices fails to connect to the assigned server, the control server assigns another server from the remaining servers to replace the original server.
